(19) United States
(12) Patent Application Publication
(10) Pub. No.: US 2005/0283772 A1
(43) Pub. Date: Dec. 22, 2005

(54) Determination of loop unrolling factor for software loops

(76) Inventors: Kalyan Muthukumar, Bangalore (IN); Jean-Francois Collard, Sunnyvale, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/874,614

(22) Filed: Jun. 22, 2004

(51) Int. Cl. G06F 9/45

(52) U.S. Cl. 717/151; 717/150; 717/160

(57) ABSTRACT

Disclosed are embodiments of a method and system for calculating an unrolling factor for software loops. The unrolling factor may be calculated by applying a formula that takes into account issue constraints of a processor. The issue constraints may include the total issue width of the processor, and may also include individual issue constraints for each instruction type. The software loop may be unrolled by the calculated unrolling factor and may be software pipelined. Other embodiments are also described and claimed.

### BACKGROUND

1. Technical Field

The present disclosure relates generally to information processing systems and, more specifically, to determining a loop unrolling factor for software loops.

2. Background Art

Software pipelining (SWP) is a compilation technique for scheduling non-dependent instructions from different logical iterations of a program loop to execute concurrently. Overlapping instructions from different independent logical iterations of the loop increases the amount of instruction level parallelism (ILP) in the program code. Code having high levels of ILP uses the execution resources available on modern, superscalar processors more effectively.

A loop is software-pipelined by organizing the instructions of the loop body into stages of one or more instructions each. These stages form a software-pipeline having a pipeline depth equal to the number of stages (the “stage count” or “SC”) of the loop body. The instructions for a given loop iteration enter the software-pipeline stage by stage, on successive initiation intervals (II), and new loop iterations begin on successive initiation intervals until all iterations of the loop have been started. Each loop iteration is thus processed in stages through the software-pipeline in much the same way that an instruction is processed in stages through a processor pipeline. When the software-pipeline is full, stages from SC sequential loop iterations are in process concurrently, and one loop iteration completes every initiation interval. Various methods for implementing software-pipelined loops are discussed, for example, in B. R. Rau, M. S. Schlansker, P. P. Tirumalai, Code Generation Schema for Modulo Scheduled Loops IEEE MICRO Conference 1992 (Portland, Oreg.) and in, B. R. Rau, M. Lee, P. P. Tirumalai, M. S. Schlansker, Register Allocation for Software-pipelined Loops, Proceedings of the SIGPLAN '92 Conference on Programming Language Design and Implementation, (San Francisco, 1992).

### BRIEF DESCRIPTION OF THE DRAWINGS

The present invention may be understood with reference to the following drawings in which like elements are indicated by like numbers. These drawings are not intended to be limiting but are instead provided to illustrate selected embodiments of a method and system for determining a loop unrolling factor.

FIG. 1 is a block diagram illustrating at least one embodiment of a resource-bound loop having a fractional initiation interval.

FIG. 2 is a flowchart illustrating at least one embodiment of a method for determining a loop unrolling factor for a software loop.

FIG. 3 is a flowchart illustrating further details for at least one embodiment of the FIG. 2 method.

FIG. 4 is a block diagram of at least one embodiment of a system capable of performing embodiments of disclosed methods.

### DETAILED DESCRIPTION

Described herein are selected embodiments of a method and system to determine a loop unrolling factor for software loops. While the embodiments are described in the context of software-pipelined loops, the determination of a loop unrolling factor may also be practiced for systems that do not perform software pipelining. Embodiments of the described method may be performed for resource-bound software loops, even if software pipelining is not performed, in order to determine a loop unrolling factor for the loop. In the following description, numerous specific details such as pseudocode instruction sequences, control flow ordering, execution resources, and the like have been set forth to provide a more thorough understanding of the present invention. It will be appreciated, however, by one skilled in the art that the embodiments may be practiced without such specific details. Additionally, some well-known structures, circuits, and the like have not been shown in detail to avoid unnecessarily obscuring the embodiments discussed herein.

Embodiments of the present invention are illustrated using instructions from the IA64™ Instruction Set Architecture (ISA) of Intel Corporation, but these embodiments may be implemented in other ISAs as well. The IA64 ISA is described in detail in the Intel® IA64 Architecture Software Developer's Guide, Volumes 1-4, which is published by Intel® Corporation of Santa Clara, Calif.

Disclosed herein are embodiments for a method and apparatus for determining an unrolling factor for software loops. For at least one embodiment, the method is performed for resource-bound loops (discussed below). For some embodiments, the method may be performed for resource-bound loops that are software pipelined. Such embodiments of the method may be better understood with reference to standard software pipelining techniques, which are discussed immediately below.

A pseudo code representation of a counted Do loop is:

| | |
|---|---|
| DO (initialize(L), test(L), update(L)) | \| |

| | | |
|---|---|---|
| a | \| | |
| b | \| | Loop(I) |

| | |
|---|---|
| ENDDO | \| |

| | |
|---|---|
| e | \| |

In this example, “DO( )” is the loop instruction, instructions “a” and “b” form the loop body, and “ENDDO” terminates the loop. The loop variable, L, tracks the number of iterations of loop(I), initialize(L) represents its initial value, and update(L) indicates how L is modified on each iteration of the loop. Test(L) is a logical function of L, e.g., L==LMAX, that terminates Loop(I) when it is true, passing control to instruction “e”. Other types of loops, e.g., “WHILE” AND “FOR” loops, follow a similar pattern, although they may not explicitly specify an initial value, and the loop variable may be updated by instructions in the loop body.

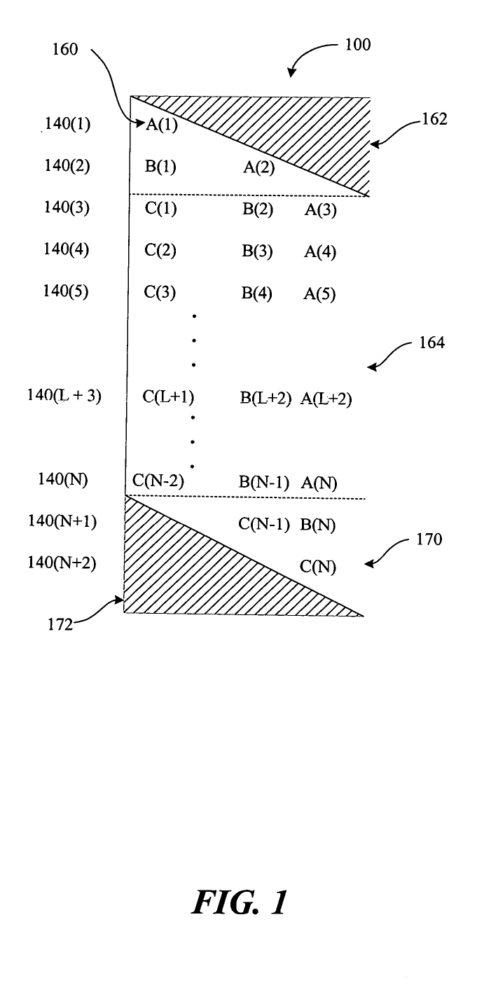

FIG. 1 represents loop (I) following software pipelining. Here, it is assumed that source code instructions a, b translate to machine language instructions A, B, and C. In a software pipeline 110, the different instructions correspond to the stages of a pipeline. Instructions in a given row of pipelined loop 100 are processed concurrently, and each instruction is evaluated for increasing values of the loop variable L in sequential rows. For purposes of illustration, the loop variable is indicated in parenthesis following each instruction. For example, A(1), B(3), and C(N−2) represent instructions A, B and C evaluated using operands appropriate for the 1^{st}, 3^{rd}, and N−2^{nd} iterations through Loop(I).

During a prolog 160, the software pipeline 100 is filled. Thus, at cycle 140(1), instruction A is executed using the operands appropriate for L=1, e.g., A(1). At cycle 140(2), instructions A and B are executed using operands appropriate for L=2 and L=1, respectively, e.g., A(2), B(1). At 140(3), A(3), B(2), and C(1) are executed. During prolog 160, resources associated with instructions B and/or C are not utilized. For example, if A, B and C are floating point instructions and Loop (I) is executed in a processor having four floating point units (FPUs), three FPUs are idle at cycle 140(1), and two are idle at cycle 140(2).

At cycle 140(3), the software pipeline 100 is filled, and instructions A, B and C are evaluated concurrently for different values of L through cycle 140(N). For cycles 140(3) through 140(N), the slots of software pipeline 100 are full. These cycles are referred to as the kernel phase 164 of the software pipeline 100. At cycle 140(N), instruction A has been evaluated for all N iterations of Loop(I).

During kernel phase 164 of the pipeline 100, resources of the processor may remain idle. For example, if A, B and C are FP instructions and Loop(i) is executed on a processor having four FPUs, one FPU remains idle even during kernel phase cycles 164 of the software pipeline 100. As such, we say that Loop (I) has a “fractional II”, because only a fraction of the execution resources are utilized during each execution cycle of the loop.

At cycles 140(N+1) and (140(N+2), software pipeline 100 empties as instructions B and C complete their N iterations of loop 100. These cycles form an epilog 170 of software pipeline 100 for which resources associated first with A and then with B are idled.

The initiation interval (II) for a software loop represents the number of processor clock cycles (“cycles”) between the start of successive iterations of the software loop. The minimum II for a loop is the larger of a resource II (RSII) and a recurrence II (RCII) for the loop. The RSII is determined by the availability of execution units for the different instructions of the loop. For example, a loop that includes three integer instructions has a RSII of at least two cycles on a processor that provides only two integer execution units. The RCII reflects cross-iteration or loop-carried dependencies among the instructions of the loop and their execution latencies. If the three integer instructions of the above-example have one cycle latencies and depend on each other as follows, inst1→inst2→inst3→inst1, the RCII is at least three cycles.

Software loops are considered to be “resource-bound” if their RSII>=RCII. For example, a loop having twelve non-dependent ALU instructions is resource-bound on a processor that can only execute six ALU instructions per cycle. Even with software pipelining, it takes two cycles to execute the loop. For such example, resource limitations (number of available execution units) drive the number of cycles to be executed in order to perform each iteration of the loop. As it happens, for this example, all six of the ALU units are utilized during each of the two cycles performed for each iteration of the software-pipelined loop. Thus, this example resource-bound loop does not have a fractional II.

However, some resource-bound loops do not fully utilize available processor resources during a given cycle, even after software pipelining. That is, some available execution units of the processor may remain unutilized during a cycle that executes instructions of a software-pipelined loop iteration. For example, consider a processor that is capable of processing two load instructions and two store instructions during a given cycle. For a loop that has one load instruction and one store instruction in its loop body, execution of a loop iteration, even after software pipelining, leaves one load unit and one store unit idle. As is indicated above, we refer to a software-pipelined loop that leaves execution resources idle during an execution cycle of the loop as having a “fractional II.” A sample loop, set forth in Example Loop 1, below, illustrates such a loop with pseudocode:

Example Loop 1:

load reg1 = a;
for (i = 0; i < N; i++) {

load reg2 = x[i];
add reg2 = reg2, reg1;
store x[i] = reg2;

}

Referring back to a previous example, Loop (I) also illustrates a loop having a fractional II. Referring to FIG. 1, for example, it is seen that a software pipelined loop having three machine instructions (A, B, and C) in its loop body will only generate three instructions, at most, during each cycle of the kernel phase 164. Assuming that the three instructions are floating point instructions, and further assuming that the processor has four FPUs, the software pipelined loop illustrated in FIG. 1 has a fractional II because it leaves at least one FPU idle during each execution cycle.

In such cases, it may be helpful to “unroll” the loop before it is software-pipelined in order to more fully utilize execution resources. Such unrolling may help to optimally use the width of the processor. Consider again Example Loop 1, described above, which has one store instruction, one floating point add instruction, and one load instruction in its loop body. Without unrolling, the II for Example Loop 1 is 1 cycle per iteration. Assuming a processor that is able to process two load instructions, two floating point instructions, and two store instructions per cycle, each iteration of the loop utilizes only ½ of the processor's load, floating point, and store execution resources. Accordingly, the II for Example Loop 1 is fractional, and unrolling may improve processor resource utilization.

Example Loop 2, below, illustrates the loop from Example Loop 1, after it has been unrolled by a factor of two. The unrolled loop now has two load instructions, two floating point instructions, and two store instructions. After unrolling and pipelining, two iterations of the loop may be executed per cycle and each cycle fully utilizes the two load, two floating point, and two store execution resources of our hypothetical processor. As such, the unrolled loop may more fully utilize the processor resources during each cycle. (One of skill in the art will realize that multiple store instructions of Example Loop 2 are shown in order to illustrate the reduced II for an unrolled loop; code optimizations that might otherwise be utilized have been eliminated for purposes of illustration).

Example Loop 2:

load reg1 = a;
for (i = 0; i < N; i+=2) {

load reg2 = x[i];
add reg2 = reg2, reg1
store x[i] = reg2;
load reg2 = x[i+1];
add reg2 = reg2, reg1;
store x[i+1] = reg2;

}

By unrolling Example Loop 1 by a factor of two, we achieve an unrolled loop (Example Loop 2) for which the II is no longer fractional. After unrolling, the loop that originally had only one load instruction, one floating point instruction, and one store instruction now has two load instructions, two floating point instructions, and two store instructions in its loop body. Both of the load execution resources as well as both of the floating point execution resources and both of the store execution resources can now be utilized during each execution cycle for Example Loop 2. Accordingly, after unrolling Example Loop 1 by a factor of 2, the II is still one cycle, but now two iterations of the original loop may be performed during each cycle. The amount of work performed during each execution cycle for the loop has thus been improved (by 100%).

Devising a formula to determine an unrolling factor for software loops, whether they are to be software-pipelined or not, poses an interesting challenge. Traditionally, the degree of loop unrolling has been determined using an ad hoc method or has been based on heuristics. A simple formula for determining an efficient unrolling factor for software-pipelined loops would be welcome. The methods and system disclosed herein address these and other issues associated with unrolling of software loops.

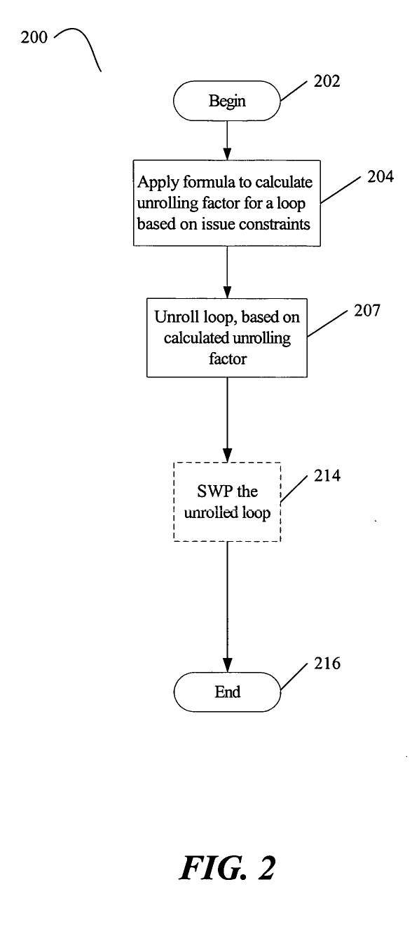

FIG. 2 illustrates at least one embodiment of a method 200 for calculating, utilizing a formula, a loop unrolling factor for a software loop. The embodiment of a formula for calculating a loop unrolling factor that is illustrated in FIG. 2 takes into account instruction issue constraints of the target processor. The formula determines an unrolling factor that complies with an issue width constraint of the target processor. The formula further determines the unrolling factor such that it also complies with individual instruction type issue constraints for each type of instruction supported by the processor.

For the embodiments discussed herein, it is assumed that the target processor supports at least two general instruction types. Accordingly, the formula illustrated in FIG. 2 takes into account at least a first instruction type issue constraint and a second instruction type issue constraint. For each general instruction type, sub-classes of instructions, along with their own specific instruction type issue constraints, may also be considered.

FIG. 2 illustrates that the method 200 begins at block 202 and proceeds to block 204. At block 204, a formula is utilized to calculate a loop unrolling factor for a loop.

Processing then proceeds to block 207. At block 207, the loop unrolling factor, which was calculated at block 204, is applied to unroll the original loop. Processing then proceeds to optional block 214. At block 214, the unrolled loop is software-pipelined. The optional nature of block 314 is denoted with broken lines in FIG. 2. Processing then ends at block 216.

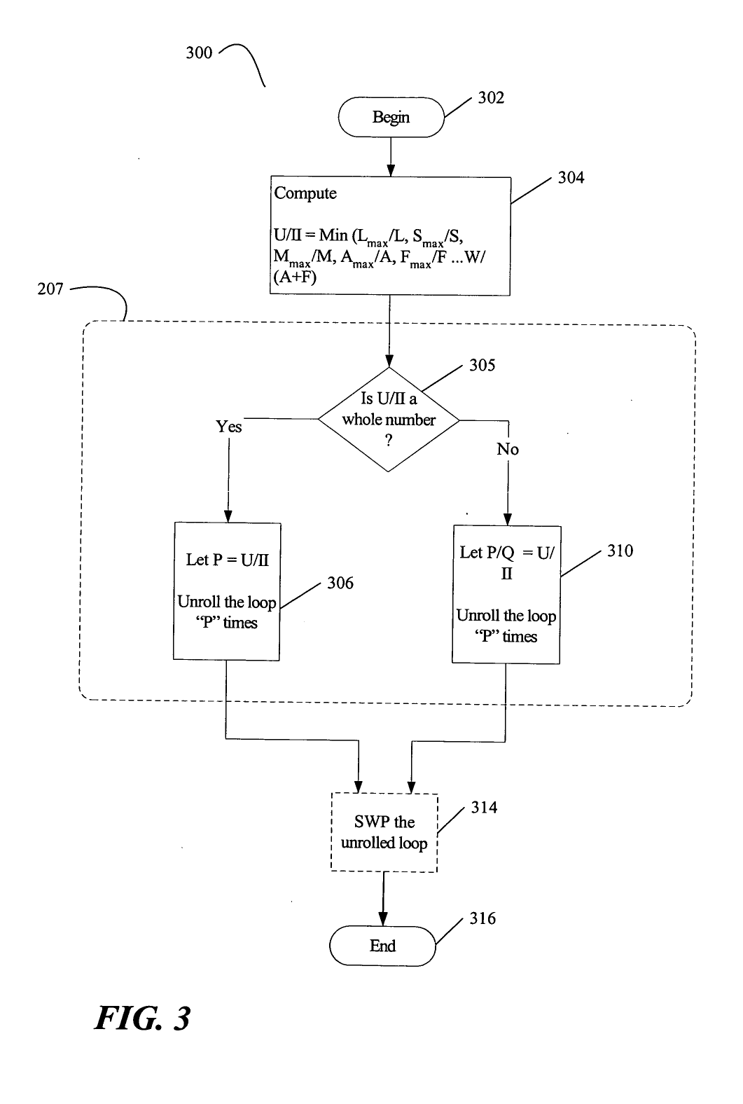

FIG. 3 illustrates further details for unrolling factor calculation 204 and loop unrolling 207, for one embodiment 300 of the method 200 illustrated in FIG. 2. In discussing the method 300, the following notation is assumed:
L—number of load instructions per iteration; subset of M and A (see below)
Lmax—maximum number of load instructions that can be issued per cycle
S—number of store instructions per iteration; subset of M and A (see below)
Smax—maximum number of store instructions that can be issued per cycle
M—number of memory instructions per iteration (L+S+prefetches); subset of A (see below)
Mmax—maximum number of memory instructions that can be issued per cycle
A—number of ALU operations per iteration (includes M)
Amax—maximum number of ALU instructions that can be issued per cycle
F—number of floating point instructions per iteration
Fmax—maximum number of floating point instructions that can be issued per cycle
W—issue width for the processor
U—the unrolling factor
N—number of instructions in original loop body
   For embodiments wherein the processor includes different or additional instruction types (generically referred to herein as X through Y), additional notation may be utilized:
X—number of X instructions per iteration
Xmax—maximum number of X instructions that can be issued per cycle
. . .
Y—number of Y instructions per iteration
Ymax—maximum number of Y instructions that can be issued per cycle

FIG. 3 illustrates a method for determining a loop unrolling factor, U, for a software loop. The method 300 is designed to determine a value for U such that processor resources are utilized more fully during execution of the unrolled loop than would otherwise be utilized without unrolling. For at least one embodiment, the method 300 strives to determine a value for U that provides optimal, or near optimal, utilization of processor resources during each execution cycle for the unrolled loop.

In the flowchart of FIG. 3, “II” is used to refer to the initiation interval of a loop after it has been unrolled by a factor of U. “II” therefore reflects the number of cycles needed to execute the unrolled loop. Thus, “II,” as used in FIG. 3, does not reflect the initiation interval for the original loop (before unrolling). The initiation interval for the original loop may be represented, based on the terminology used in FIG. 3, as II/U.

For at least one embodiment, the method 300 illustrated in FIG. 3 strives to calculate an unrolling factor that maximizes the number of iterations (U) that can be performed in a given number of cycles (II), without leaving processor resources idle. Such goals, for at least one embodiment, are subject to certain constraints. These constraints originate in the instruction issue constraints discussed briefly above in connection with FIG. 2.

One constraint is that the number of instructions of a particular instruction type issued in II cycles cannot exceed the maximum number of instructions of that type that can be executed by the particular processor during II cycles. For instance, the number of load instructions issued during U iterations of the loop is constrained to a number of such instructions that can be executed during II cycles. Accordingly, U*L should be less than or equal to Lmax*II (that is, U*L≦Lmax*II). Similarly, this instruction-type issue constraint is applicable to the other instruction types supported by the processor: U*S≦Smax*II; U*M≦Mmax*II; U*A≦Amax*II; U*F≦Fmax*II.

For example, consider an unrolled loop having an II of 2 cycles. Assume that the processor can execute four load instructions per cycle (Lmax=4). In such case, a maximum of eight load instructions may be issued for each iteration of the unrolled loop (II*Lmax=8). Accordingly, U*L for the unrolled loop should not exceed the eight-instruction limitation.

Continuing with the above example, consider a loop having three load instructions in the original loop body before unrolling. If the original loop is unrolled by a factor of two (U=2), then the unrolled loop contains U*L load instructions: 2*3=6 load instructions. Since six is less than eight, the constraint is satisfied. Stated another way, the following constraint is satisfied: U*L≦Lmax*II.

As another example, consider an unrolled loop having an II of 4 cycles. Assume again that the processor can execute four load instructions per cycle (Lmax=4). In such case, a maximum of sixteen load instructions may be issued for each iteration of the unrolled loop (II*Lmax=16). Accordingly, U*L for the unrolled loop should not exceed the sixteen-instruction limitation.

Continuing with the above example, consider a loop having six load instructions in the original loop body (L=6). If the loop is unrolled by a factor of three (U=3), then the unrolled loop body includes 18 load instructions (U*L=3*6=18). For this example, then, the instruction-type issue constraint of U*L≦Lmax*II is not satisfied, because U*L (18) is greater than II*Lmax (16).

For a processor having the instruction types discussed above, the instruction-type issue constraint can be generalized to all instruction types. That is, for a processor having the five instruction types discussed above, five constraints should be satisfied when an unrolling factor is being determined:
U*L≦Lmax*II
U*S≦Smax*II
U*M≦Mmax*II
U*A≦Amax*II
U*F≦Fmax*II

In addition, for a processor that includes additional instructions types X . . . Y, the following additional instruction-type issue constraints should also be satisfied:
U*X≦Xmax*II
U*Y≦Ymax*II

Each of these constraints can be simplified as follows:
U*L≦Lmax*II=>U/II≦Lmax/L
U*S≦Smax*II=>U/II≦Smax/S
U*M≦Mmax*II=>U/II≦Mmax/M
U*A≦Amax*II=>U/II≦Amax/A
U*F≦Fmax*II=>U/II≦Fmax/F
U*X≦Xmax*II=>U/≦Xmax/X
U*Y≦Ymax*II=>U/II≦Ymax/Y

Another constraint reflected in the formula utilized at block 304 is that, for at least one embodiment, the processing 304 further computes the unrolling factor such that the number of instructions per cycle for the unrolled loop does not exceed the processor's issue width. W reflects the issue width of the processor. The issue width is the maximum number of instructions that can be issued in a single cycle for a given processor.

Consider, for example, a processor that can issue six instructions per cycle (that is, W=6). Assume, for purposes of example, that such processor includes six ALU execution units (Amax=6) and two floating point execution units (Fmax=2). In theory, then, without consideration of W, the processor could issue six ALU instructions and two floating point instructions per cycle. However, if W=6, then the processor can only execute six, rather than eight, instructions per cycle.

Consider, for example, a loop that includes eight instructions in its loop body—six ALU instructions and two floating point instructions—on a processor for which Amax=6 and Fmax=2. Although, individually, the number of ALU instructions in the loop body is not more than Amax and the number of floating point instructions in the loop body is not more than Fmax, all instructions of the loop body cannot be executed in a single cycle because the number of instructions in the loop body exceeds W.

FIG. 3 illustrates that processing for the method 300 begins at block 302 and proceeds to block 304. At block 304, a value representing U/II for the subject loop is determined, subject to the constraints discussed above. Block 304 illustrates that such value is determined by resolving a “Min” function. That is, for at least one embodiment, U/II is determined as the minimum value from a set of parameter values.

The set of parameter values illustrated at block 304 are based on the constraints discussed above. The first five parameters of the “Min” function illustrated at block 304 are based on the five simplified instruction-type issue constraints discussed above:
U/II≦Lmax/L
U/II≦Smax/S
U/II≦Mmax/M
U/II≦Amax/A
U/II≦Fmax/F

The final parameter of the “Min” function illustrated at block 304 takes the target processor's issue width into account. The issue width for an unrolled loop having an initiation interval of II cycles is II*W. II*W reflects the maximum number of instructions (all instruction types) that can be executed by the processor during II cycles. Thus, the total number of instructions in an unrolled loop iteration should be less than or equal to II*W. This constraint is referred to herein as the issue width constraint.

For at least one embodiment, the total number of instructions in an unrolled loop body, where N represents the number of instructions in the original loop body, is represented by U*N. However, for most embodiments, an unrolled loop includes not only the instructions of the loop body but also includes at least one branch instruction. The branch instruction at the end of the loop body determines whether control should remain in the loop (branch back to the beginning of the loop body) or should branch out of the loop. In an unrolled loop, this branch instruction is not repeated U times, but remains as a single instruction at the end of the loop body. Accordingly, the number of instructions in an unrolled loop is represented, for at least one embodiment, as U*N+1.

Assuming that those N instructions are of instruction types supported by the processor, N can be further broken down into the count for each type of instruction. Assuming that the processor supports two major classes of instructions, such as ALU instructions and FP instructions as discussed above, N=A+F. Accordingly, for at least one embodiment the number of instructions in an unrolled loop may be represented as U*(A+F)+1.

The issue width constraint, discussed above, states that the total number of instructions per cycle for the unrolled loop should be constrained by the total number of instructions that can be executed in II cycles. The issue width constraint may be expressed as: U*(A+F)+1≦W*II. Such expression may be simplified to: U/II≦W/(A+F)−1/II*(A+F). Such expression may be utilized as the sixth term for the “Min” function shown at block 304 of FIG. 3.

Accordingly, block 304 illustrates that U/II for a subject loop may be determined as: U/II=Min (Lmax/L, Smax/S, Mmax/M, Amax/A, Fmax/F, . . . , W/(A+F)−1/(II*(A+F)))). The determination of U/II may be simplified if one considers that the goal for at least one embodiment is to unroll as much as possible while conforming to the six constraints discussed above. Accordingly, it is desirable to have a large U value. As the value of U goes up, the value of II also increases.

If we tend II to infinity, then the factor “1/(II*(A+F))” is eliminated: 1/(∞*(A+F) [symbol] 1/∞ [symbol] 0. Accordingly, the determination of U/II becomes: U/II=Min (Lmax/L, Smax/S, Mmax/M, Amax/A, Fmax/F, . . . , W/(A+F). Such determination is based on an assumption, which is discussed immediately below.

The embodiment illustrated in FIG. 3 assumes that a subject processor provides two classes of execution resources, each for processing an associated instruction type. These two classes include floating point execution units for processing floating point (“F”) instructions and ALU (arithmetic logic unit) execution units for processing ALU (“A”) instructions such as integer and logical instructions. For at least one embodiment, ALU instructions (“A”) include memory instructions, such as loads (“L”) and stores (“S”). Of course, other embodiments may provide other types of execution resources for executing other instruction types. As is stated above, such other instruction types may be denoted as X . . . Y. For such embodiments, the ellipses at block 304 are intended to denote additional parameters for the Min function. These additional parameters may include Xmax/X and/or Ymax/Y. In such case, the term “(A+F)” in the final parameter of the Min function illustrated at block 304 for such other embodiments is to be revised to take the additional instruction types into account.

Also, one should note that only those terms of the Min function that are applicable to the loop of interest need be evaluated. For example, if the loop of interest does not include any store instructions, then the parameter for store instructions, Smax/0, is not defined. Accordingly, parameters are only considered at block 304 for those instruction types that are present in the loop of interest.

FIG. 3 illustrates that, after U/II is calculated at block 304, processing proceeds to block 305. Block 305, along with blocks 306 and 310, represents at least one embodiment of loop unrolling illustrated at block 207 of FIG. 2. The loop unrolling 207, for the embodiment illustrated in FIG. 3, takes into account whether the value of U/II calculated at block 304 is a whole number. At block 305, it is determined whether U/II is a whole number. If so, then processing proceeds to block 306. Otherwise, processing proceeds to block 310.

At block 306, the loop is unrolled by the whole number value, called P, that was calculated at block 304. That is, the loop is unrolled by a whole number P, where P is the value for U/II that was calculated at block 304. If software-pipelined, such loop will have an II of 1 cycle. In other words, each iteration of the original loop executes in 1/P cycles. From block 306, processing proceeds to block 314.

As an example to illustrate the processing of blocks 304, 305 and 306 in further detail, consider the following sample pseudocode, to be performed on a processor, having an issue width of six instructions, that can execute four floating point load instructions per cycle, and can execute two floating point arithmetic instructions per cycle:

Example Loop 3:

sum = 0;
for (i = 0; I < N; i++) {

sum += x[i];
}

Assuming that sum is an array of floating-point values, the “for” loop set forth in Example Loop 3 could translate into one load instruction and one floating point addition instruction, in addition to the loop-closing branch. As is stated above, Lmax for our sample processor is four, Fmax is two and W is six. Also assume that the processor can execute four memory instructions per cycle (Mmax=4), six ALU instructions per cycle (Amax=6), and two store instructions (Smax=2) per cycle.

At block 304, U/II is calculated for Example Loop 3 as: U/II=Min (Lmax/L, Smax/S, Mmax/M, Amax/A, Fmax/F, W/(A+F)). The Smax/S parameter is not applicable because Example Loop 3 does not include any store instructions. It is assumed that the load instruction is an ALU instruction (A), as well as a memory instruction (M) and a load instruction (L). The expression evaluates to: U/II=Min (4/1, 4/1, 6/1, 2/1, 6/(1+1)) [symbol] U/II=2/1. Thus, the unrolling factor calculated at block 304 for Sample Loop 3 is 2. The throughput for the original loop, given this unrolling factor, is 0.5 cycles for each iteration of the original loop. That is, each iteration of the original loop is executed in ½ cycles.

As another example, refer again to Example Loop 3 and assume that sum is an array of integer values. The “for” loop set forth in Example Loop 3 could then translate into one integer load instruction and one ALU addition instruction, in addition to the loop-closing branch. Assume that our sample processor can process only two integer load instructions per cycle: Lmax=2. Also assume that W=6, and that the processor can execute four memory instructions per cycle (Mmax=4), two FP instructions per cycle (Fmax=2), and two store instructions (Smax=2) per cycle.

At block 304, U/II is calculated for Example Loop 3 (integer) as: U/II=Min (Lmax/L, Smax/S, Mmax/M, Amax/A, Fmax/F, W/(A+F)). The Smax/S and Fmax/F parameters are not applicable because Example Loop 3 does not include any store instructions nor floating point instructions. Again, it is assumed that the load instruction is an ALU instruction (A), as well as a memory instruction (M) and a load instruction (L). The expression evaluates to: U/II=Min (2/1, 4/1, 6/2, 6/(2+0)) [symbol] U/II=2/1. Thus, the unrolling factor calculated at block 304 for Example Loop 3 (integer) is 2. The throughput for the original loop, given this unrolling factor, is 0.5 cycles for each iteration of the original loop. That is, each iteration of the original loop is executed in ½ cycles.

At block 310, the loop is unrolled by the a factor P, where P is the numerator of the value calculated at block 304. For example, if the value U/II calculated at block 304 is a fraction, represented by P/Q, then the loop is unrolled P times. Stated another way, the value P/II is calculated at block at block 304, and the loop is unrolled P times at block 310. As a result, the unrolled loop has an II of Q cycles. That is, each iteration of the original loop executes in Q/P cycles.

As an example to illustrate the processing of blocks 304, 305 and 310 in further detail, consider a loop, referred to herein as Example Loop 4, which includes nine ALU instructions for its loop body. Assume that the ALU instructions of Example Loop 4 are to be performed on a processor having an issue width of six instructions and that can execute six ALU instructions per cycle. This loop will be unrolled by 2 using our method, and the resultant unrolled loop will have an II of 3 cycles, i.e. P=2, and Q=3.

From block 310, processing proceeds to block 314. At block 314, the unrolled loop is software pipelined. Again, the optional nature of block 314 is denoted with broken lines in FIG. 3. Processing then ends at block 316.

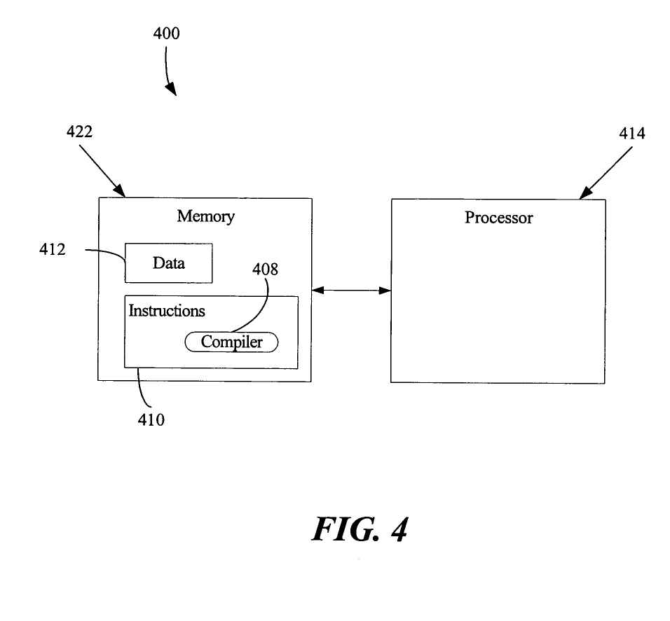

The foregoing discussion discloses selected embodiments of a formula-based method for determining a loop unrolling factor for a software loop. Such embodiments may be utilized on a processing system such as the processing system 400 illustrated in FIG. 4.

Embodiments of the methods disclosed herein may be implemented in hardware, software, firmware, or a combination of such implementation approaches. Software embodiments of the methods may be implemented as computer programs executing on programmable systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion. For purposes of this disclosure, a processing system includes any system that has a processor, such as, for example; a network processor, a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the methods described herein are not limited in scope to any particular programming language. In any case, the language may be a compiled or interpreted language

The programs may be stored on a storage media or device (e.g., hard disk drive, floppy disk drive, read only memory (ROM), CD-ROM device, flash memory device, digital versatile disk (DVD), or other storage device) accessible by a general or special purpose programmable processing system. The instructions, accessible to a processor in a processing system, provide for configuring and operating the processing system when the storage media or device is read by the processing system to perform the actions described herein. Embodiments of the invention may also be considered to be implemented as a machine-readable storage medium, configured for use with a processing system, where the storage medium so configured causes the processing system to operate in a specific and predefined manner to perform the functions described herein.

An example of one such type of processing system is shown in FIG. 4. System 400 may be used, for example, to execute the processing for a method of determining a loop unrolling factor for a software loop, such as the embodiments described herein. System 400 is representative of processing systems based on the Itanium® and Itanium® 2 microprocessors and the Pentium®, Pentium® Pro, Pentium® II, Pentium® II, Pentium® 4 microprocessors, all of which are available from Intel Corporation. Other systems (including personal computers (PCs) and servers having other microprocessors, engineering workstations, personal digital assistants and other hand-held devices, set-top boxes and the like) may also be used. At least one embodiment of system 400 may execute a version of the Windows™ operating system available from Microsoft Corporation, although other operating systems and graphical user interfaces, for example, may also be used.

Processing system 400 includes a memory 422 and a processor 414. Memory system 422 may store instructions 410 and data 412 for controlling the operation of the processor 414. Memory system 422 is intended as a generalized representation of memory and may include a variety of forms of memory, such as a hard drive, CD-ROM, random access memory (RAM), dynamic random access memory (DRAM), static random access memory (SRAM), flash memory and related circuitry.

Memory system 422 may store instructions 410 and/or data 412 represented by data signals that may be executed by the processor 414. The instructions 410 may include a compiler 408. For at least one embodiment, a compiler 408 performs methods 200 (FIG. 2) and/or 300 (FIG. 3).

In the preceding description, various embodiments of a method and system for determining a loop unrolling factor for loops are disclosed. For purposes of explanation, specific numbers, examples, systems and configurations were set forth in order to provide a more thorough understanding. However, it is apparent to one skilled in the art that the described embodiments of a system and method may be practiced without the specific details. It will be obvious to those skilled in the art that changes and modifications can be made without departing from the present invention in its broader aspects.

For example, the methods 200 (FIG. 2), 300 (FIG. 3) discussed herein have been illustrated as having a particular control flow. One of skill in the art will recognize that alternative processing order may be employed to achieve the functionality described herein. Similarly, certain operations are shown and described as a single functional block. Such operations may, in practice, be performed as a series of sub-operations.

In the preceding description, various aspects of an apparatus and method to determine a loop unrolling factor for a software loop are disclosed. For purposes of explanation, specific numbers, examples, systems and configurations were set forth in order to provide a more thorough understanding. However, it is apparent to one skilled in the art that the described apparatus and system may be practiced without the specific details. It will be obvious to those skilled in the art that changes and modifications can be made without departing from the present invention in its broader aspects. While particular embodiments of the present invention have been shown and described, the appended claims are to encompass within their scope all such changes and modifications that fall within the true scope of the present invention.

1. A method comprising:
utilizing a formula to determine, based on a processor's instruction issue constraints, an unrolling factor (P) for a software loop having a loop body; and
unrolling the software loop to include P iterations of the loop body;

2. The method of claim 1, wherein utilizing a formula further comprises:
utilizing the formula to determine an unrolling factor (P) that complies with an issue width constraint.

3. The method of claim 1, wherein utilizing a formula further comprises:
utilizing the formula to determine an unrolling factor (P) that complies with a first instruction type issue constraint.

4. The method of claim 3, wherein utilizing a formula further comprises:
utilizing the formula to determine an unrolling factor (P) that complies with a second instruction type issue constraint.

5. The apparatus of claim 4, wherein utilizing a formula further comprises:
utilizing the formula to determine an unrolling factor (P) that complies with an issue width constraint.

6. The method of claim 1, wherein:
utilizing a formula to determine P further comprises utilizing the formula to determine U/II, wherein:
U is the number of iterations of the loop body in the unrolled loop; and
II is the number of machine cycles to execute the instructions of the unrolled loop.

7. The method of claim 1, wherein:
utilizing a formula to determine P further comprises utilizing the formula to determine P/II, wherein II is the number of machine cycles to execute the instructions of the unrolled loop.

8. A method, comprising:
determining, for each of a plurality of instruction types, the number of instructions in the loop body of a software loop;
determining the total number of instructions in the loop body; and
determining an unrolling factor (U) for the software loop such that [U*(total instructions of the loop body)+1] is less than or equal to (a processor issue width*an initiation interval (II)) and such that the number of instructions for each instruction type, when multiplied by U, is less than or equal to II*an instruction type max value for that instruction type.

9. The method of claim 8, further comprising:
unrolling the software loop by a factor of U/II, if U/II is a whole number, to generate an unrolled loop.

10. The method of claim 9, further comprising:
software pipelining the unrolled loop.

11. The method of claim 8, further comprising:
unrolling the software loop by a factor of U if U/II is not a whole number, to generate an unrolled loop.

12. The method of claim 11, further comprising:
software pipelining the unrolled loop.

13. The method of claim 8, wherein:
the instruction types include an arithmetic logic unit (ALU) instruction type.

14. The method of claim 8, wherein:
the instruction types include a floating point instruction type.

15. The method of claim 8, wherein:
the instruction types include a memory instruction type.

16. A system comprising:
a processor;
a memory system; and
instructions stored in the memory system;
wherein the instructions include a compiler to determine a loop unrolling factor for a software loop, the compiler further to determine the loop unrolling factor based on a formula that takes into account issue constraints of the processor.

17. The system of claim 16, wherein:
The memory system includes a DRAM.

18. The system of claim 16, wherein:
the compiler is further to determine the loop unrolling factor such that, when the software loop is unrolled by the unrolling factor, the number of instructions in the unrolled loop does not exceed the per-cycle issue width of the processor.

19. The system of claim 16, wherein:
the compiler is further to determine the loop unrolling factor such that, when the software loop is unrolled by the unrolling factor, the number of a first type of instructions in the unrolled loop does not exceed a constraint value for the first instruction type.

20. The system of claim 19, wherein:
the constraint value for the first instruction type further comprises a maximum value for the first instruction type multiplied by the initiation interval of the software loop.

21. The system of claim 20, wherein:
the compiler is further to determine the loop unrolling factor such that, when the software loop is unrolled by the unrolling factor, the number of a second type of instructions in the unrolled loop does not exceed a constraint value for the second instruction type.

22. The system of claim 21, wherein:
the constraint value for the second instruction type further comprises a maximum value for the second instruction type multiplied by the initiation interval of the software loop.

23. An article comprising:
a storage medium having a plurality of machine accessible instructions, which if executed by a machine, cause the machine to perform the following operations:
utilizing a formula to determine, based on a processor's instruction issue constraints, an unrolling factor (P) for a software loop having a loop body; and
unrolling the software loop to include P iterations of the loop body.

24. The article of claim 23, wherein the instructions, which if executed by a machine, cause the machine to perform utilizing a formula further comprise instructions, which if executed by a machine, cause the machine to perform:
utilizing the formula to determine an unrolling factor (P) that complies with an issue width constraint.

25. The article of claim 23, wherein the instructions, which if executed by a machine, cause the machine to perform utilizing a formula further comprise instructions, which if executed by a machine, cause the machine to perform:
utilizing the formula to determine an unrolling factor (P) that complies with a first instruction type issue constraint.

26. The article of claim 25, wherein the instructions, which if executed by a machine, cause the machine to perform utilizing a formula further comprise instructions, which if executed by a machine, cause the machine to perform:
utilizing the formula to determine an unrolling factor (P) that complies with a second instruction type issue constraint.

27. The article of claim 26, wherein the instructions, which if executed by a machine, cause the machine to perform utilizing a formula further comprise instructions, which if executed by a machine, cause the machine to perform:
utilizing the formula to determine an unrolling factor (P) that complies with an issue width constraint.

28. The article of claim 23, wherein the instructions, which if executed by a machine, cause the machine to perform utilizing a formula to determine P further comprise instructions, which if executed by a machine, cause the machine to perform:
utilizing the formula to determine P=U/II, wherein:
U is the number of iterations of the loop body in the unrolled loop; and
II is the number of machine cycles to execute the instructions of the unrolled loop.

29. The article of claim 23, wherein the instructions, which if executed by a machine, cause the machine to perform utilizing a formula to determine P further comprise instructions, which if executed by a machine, cause the machine to perform:
utilizing the formula to determine P/II, wherein II is the number of machine cycles to execute the instructions of the unrolled loop.

30. The article of claim 23, wherein the instructions, which if executed by a machine, cause the machine to perform utilizing a formula further comprise instructions, which if executed by a machine, cause the machine to perform:
determining, for each of a plurality of instruction types, the number of instructions in the loop body of a software loop;
determining the total number of instructions in the loop body; and
determining an unrolling factor (U) for the software loop such that [U*(total instructions of the loop body)+1] is less than or equal to (a processor issue width*an initiation interval (II)) and such that the number of instructions for each instruction type, when multiplied by U, is less than or equal to II*an instruction type max value for that instruction type.
